(19) United States
(12) Patent Application Publication
(10) Pub. No.: US 2008/0006965 A1
(43) Pub. Date: Jan. 10, 2008

(54) Method for forming seat and back of a mesh chair

(76) Inventor: Feng-Tien Hsien, Ma Tou (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/481,832

(22) Filed: Jul. 7, 2006

(51) Int. Cl. B29C 45/14

(52) U.S. Cl. 264/259; 264/491; 264/328.1

(57) ABSTRACT

To form a seat/back of a mesh chair, firstly a piece of elastic mesh is cut into an elastic mesh part whose circumferential shape is the same as that of a seat/back of a mesh chair, secondly a frame is positioned on a periphery of the elastic mesh part, thirdly the periphery of the elastic mesh part is wrapped around and joined to the frame such that the elastic mesh part has a fixed shape, and finally the elastic mesh part together with the frame are positioned in a mold, and injection molding is carried out so as to form a plastic layer completely covering the periphery of the elastic mesh part and the frame; thus, a finished chair seat/back is formed with the elastic mesh part being securely joined to the frame.

### BACKGROUND OF THE INVENTION

1. Field of the Invention

The present invention relates to a method for forming seat and back of a mesh chair, according to which method a frame is joined to a periphery of an elastic mesh part, and a plastic layer is formed to completely cover the frame and the periphery of the elastic mesh part by means of injection molding.

2. Brief Description of the Prior Art

Office chairs and domestic chairs can be made of wood, iron, plastic or leather. Currently, mesh chairs are also available whose seats and backs have elastic mesh parts for supporting sitters' buttocks and backs. Referring to FIG. 6, a currently existing mesh chair seat includes a base 71, a foam material layer 72, and a mesh part 73. The base 71 can be made of wood or iron, and is hollow on a middle portion thereof. The foam material 72 is made by means of cutting a foam material into a loop-shape the same as that of the base 71, and is secured on an upper side of the base 71. The mesh part 73 has a greater circumference than the base 71 and the foam material layer 72, and is positioned over an upper side of the foam material layer 72 and the hollowness within the foam material layer 72, and covers the circumferential portions of the foam material layer 72 and the base 71 as well as the periphery of a lower side of the base 71, and fixing elements such as screws, nails, and staples are used to fix the mesh part 73 to the lower side of the base 71.

It takes a relatively complicated process and high cost to manufacture above mesh seat; the foam material layer 72 has to be made by means of cutting, and mesh material isn't used in an economical way because the mesh part 73 has to be so large as to cover the periphery of the lower side of the base 71, and the mesh part has to be held in position by means of a machine when it is being joined to the base and the foam material layer; furthermore, the mesh part has to be joined to the base and the foam material layer carefully otherwise it won't have a proper degree of tightness; owing to sitters' body weight, the mesh part is prone to split and break at bending portions thereof, which cover angular portions of the base, after it has been used for a certain length of time.

### SUMMARY OF THE INVENTION

It is a main object of the present invention to provide a method for forming seat and back of a mesh chair to overcome the above-mentioned problems. According to the method of the present invention, firstly a piece of elastic mesh is cut into an elastic mesh part whose circumferential shape is same as that of a seat/back of a mesh chair, secondly a frame is positioned on a periphery of the elastic mesh part, thirdly the periphery of the elastic mesh part is wrapped around and joined to the frame for making the elastic mesh part have a fixed shape, and finally the elastic mesh part together with the frame are positioned in a mold, and injection molding is carried out so as to form a plastic layer completely covering the periphery of the elastic mesh part and the frame. Consequently, the elastic mesh part is securely joined to the frame.

### BRIEF DESCRIPTION OF THE DRAWINGS

The present invention will be better understood by referring to the accompanying drawings, wherein:

FIG. 1 is a block diagram of the method in the present invention,

FIG. 2 is a flow chart of the method for making a mesh chair seat in the present invention,

FIG. 3 is a flow chart of the method for making a mesh chair back,

FIG. 4 is a perspective view of a chair according to the invention,

FIG. 5 is a view of the second preferred embodiment of a mesh chair back, and

FIG. 6 is a sectional view of the prior art.

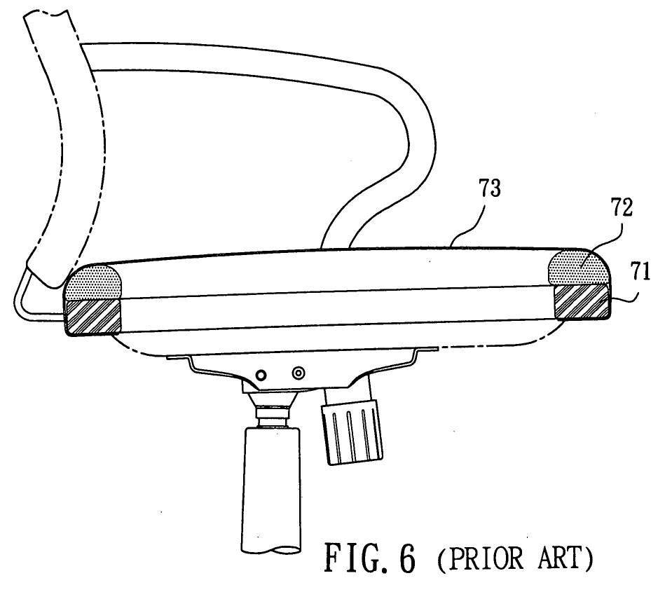

### DETAILED DESCRIPTION OF THE PREFERRED EMBODIMENTS

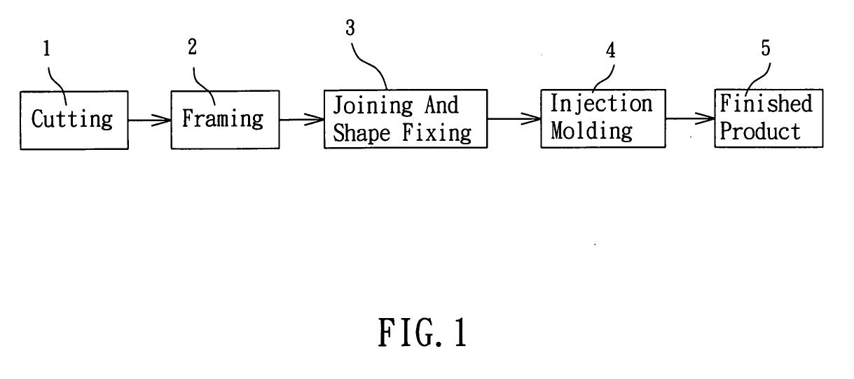

Referring to FIGS. 1 to 4, a method for forming seat and back of a mesh chair includes the following steps:

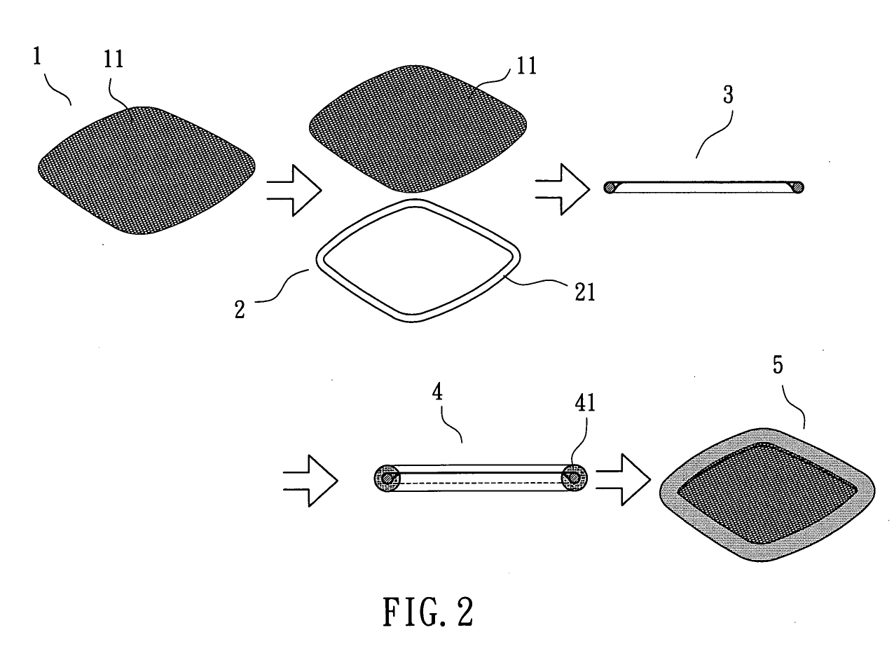

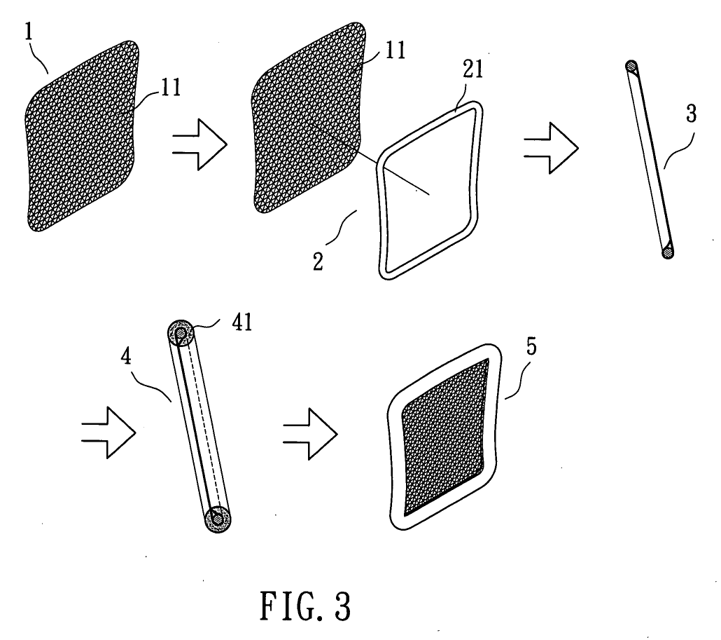

(1) cutting; a piece of elastic mesh is cut so as to make an elastic mesh part 11 whose circumferential shape is the same as that of a seat (FIG. 2)/back (FIG. 3); the elastic mesh can be a piece of cloth mesh;

(2) framing; a frame 21 is positioned on a periphery of the elastic mesh part 11, which frame 21 has the same shape as the circumferential shape of the elastic mesh part 11;

(3) joining and shape fixing; the periphery of the elastic mesh part 11 is wrapped around and joined to the frame 21 such that the elastic mesh part 11 has a fixed shape; the elastic mesh part 11 can be joined to the frame 21 by means of machine sewing; or alternatively, the elastic mesh part 11 can be joined to the frame 21 by means of high frequency heating and hot pressing; and

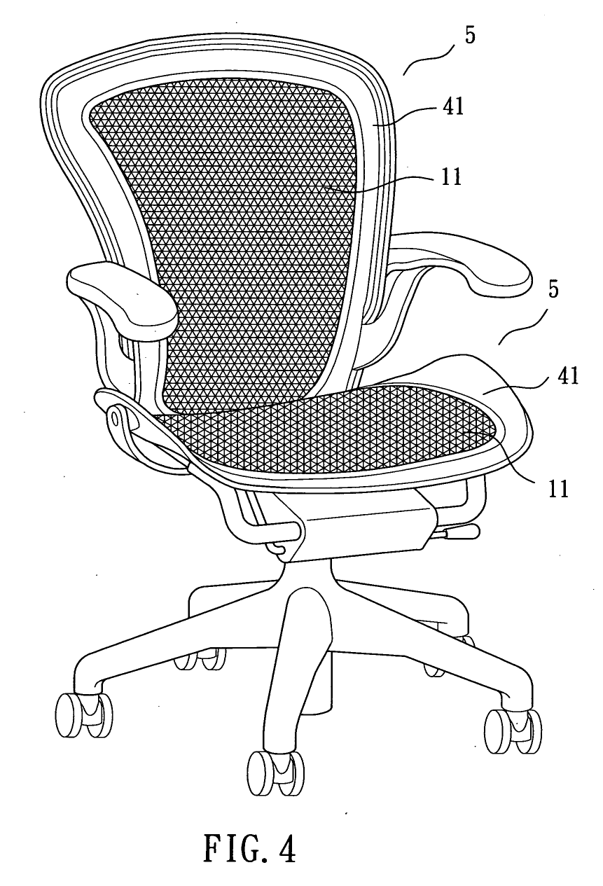

(4) injection molding; the elastic mesh part 11 together with the frame 21 are positioned in a mold, and injection molding is carried out so as to form a plastic layer 41 completely covering the periphery of the elastic mesh part 11 and the frame 21; thus, a finished product (chair seat/back) 5 is formed, which can be fitted on a chair for use as shown in FIG. 4.

Referring to FIG. 4, a chair has the mesh seat/back 5 fitted thereon, which includes an elastic mesh part 11, a frame 21 joined to the periphery of the elastic mesh part 11 to make the elastic mesh part 11 have a fixed shape, and a plastic layer 41 completely covering the periphery of the elastic mesh part 11 as well as the frame 21, and which only has the elastic mesh part 11 on a middle portion thereof.

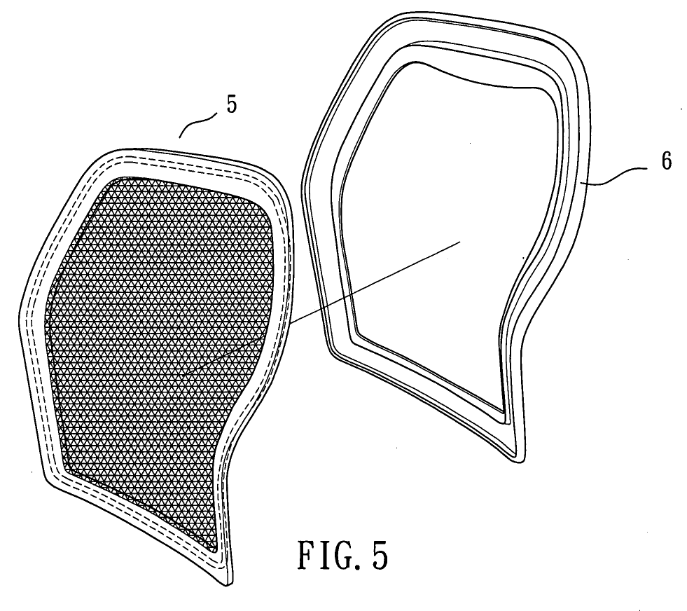

Referring to FIG. 5, the finished product (seat/back) 5 of the present invention is further joined to a supporting member 6 with a certain shape so as to be more pleasant-looking, attractive and strong.

From the above description, it can be seen that the method of the present invention for forming seat and back of a mesh chair has the following advantages over the conventional one:

1. The method of the present invention includes four steps, cutting, framing, joining, and plastic injection, one immediately following another therefore the method has a simpler process than the conventional one. The manufacturing time and cost will reduce if the method of the present invention is used.

2. The periphery of the elastic mesh part of a mesh seat/back made according to the present method is securely joined to and protected by the plastic layer. Consequently, the elastic mesh part has a greater elasticity than those made according the conventional method.

What is claimed is:

1. A method for forming a seat/back of a mesh chair, comprising steps:
(1) cutting; a piece of elastic mesh is cut into an elastic mesh part whose circumferential shape is same as that of a seat/back of a mesh chair;
(2) framing; a frame is positioned on a periphery of the elastic mesh part;
(3) joining and shape fixing; the periphery of the elastic mesh part is wrapped around and joined to the frame such that the elastic mesh part has a fixed shape; and
(4) injection molding; the elastic mesh part together with the frame are positioned in a mold, and injection molding is carried out so as to form a plastic layer completely covering the periphery of the elastic mesh part and the frame; thus, a finished chair seat/back is formed.

2. The method for forming a seat/back of a mesh chair as recited in claim 1, wherein the elastic mesh part is joined to the frame by means of machine sewing.

3. The method for forming a seat/back of a mesh chair as recited in claim 1, wherein the elastic mesh part is joined to the frame by means of high frequency heating and hot pressing.

4. The method for forming a seat/back of a mesh chair as recited in claim 1, wherein the elastic mesh is a piece of cloth mesh.

5. The method for forming a seat/back of a mesh chair as recited in claim 1, wherein the finished chair seat/back is joined to a shaped supporting member.
